(19) United States
(12) Patent Application Publication
(10) Pub. No.: US 2025/0391324 A1
(43) Pub. Date: Dec. 25, 2025

(54) DISPLAY DEVICE, METHOD OF DRIVING THE SAME, AND ELECTRONIC APPARATUS INCLUDING THE SAME

(71) Applicant: SAMSUNG DISPLAY CO., LTD., YONGIN-SI (KR)

(72) Inventors: SEHYUK PARK, YONGIN-SI (KR); DONGGYU LEE, YONGIN-SI (KR); YOUNGHA SOHN, YONGIN-SI (KR); JIN-WOOK YANG, YONGIN-SI (KR); JAE-HYEON JEON, YONGIN-SI (KR)

(21) Appl. No.: 19/061,030

(22) Filed: Feb. 24, 2025

(30) Foreign Application Priority Data
Jun. 20, 2024 (KR) 10-2024-0080010

(51) Int. Cl. G09G 3/32

(52) U.S. Cl. CPC G09G 3/32; G09G 2300/0814; G09G 2310/08; G09G 2320/0233; G09G 2320/0247; G09G 2340/0435

(57) ABSTRACT

A display device includes a display panel including a plurality of pixels. The display device displays an image at a variable driving frequency. The display device further includes an emission driver which provides an emission signal to the pixels, and a controller which performs a cycle differential driving operation in which lengths of emission periods defined by the emission signal gradually increase in a frame. The controller omits the cycle differential driving operation when a change in the variable driving frequency corresponds to a frequency difference that is greater than or equal to a threshold frequency difference.

### CROSS-REFERENCE TO RELATED APPLICATION(S)

This application claims priority under 35 U.S.C. § 119 to Korean Patent Application No. 10-2024-0080010, filed on Jun. 20, 2024, the disclosure of which is incorporated by reference herein in its entirety.

### TECHNICAL FIELD

Embodiments of the present disclosure relate to a display device. More particularly, embodiments of the present disclosure relate to a display device driven at a variable refresh rate, a method of driving the display device, and an electronic apparatus including the display device.

### DISCUSSION OF RELATED ART

A display device may include a display panel and a display panel driver. The display panel may include a plurality of pixels. The display panel driver may include a gate driver that provides a gate signal to the pixel, an emission driver that provides an emission signal to the pixel, a data driver that provides a data voltage to the pixel, and a controller that controls the gate driver, the emission driver, and the data driver.

In a display panel driven by a variable refresh rate (VRR) method, an operation period of the display panel may include a writing period and a holding period. Since hysteresis characteristics of a driving transistor of the pixel are different in the writing period and the holding period, when a driving frequency of the display panel changes from a high frequency to a low frequency, a luminance deviation of the display panel may occur. A user may recognize a flicker due to the luminance deviation.

During low-frequency driving, when holding periods continue, a luminance of the display panel may decrease. To compensate for the decrease in luminance of the display panel, a cycle differential driving (CDD) in which lengths of emission periods in one frame gradually increase may be performed. However, when the cycle differential driving is performed and the driving frequency of the display panel changes from the high frequency to the low frequency, the luminance deviation of the display panel may be further aggravated.

### SUMMARY

Embodiments of the present disclosure provide a display device in which luminance deviation is improved, a method of driving the display device, and an electronic apparatus including the display device.

According to an embodiment of the present disclosure, a display device includes a display panel including a plurality of pixels, which is configured to display an image at a variable driving frequency, an emission driver configured to provide an emission signal to the plurality of pixels, and a controller configured to perform a cycle differential driving operation in which lengths of emission periods defined by the emission signal gradually increase in a frame. The controller omits the cycle differential driving operation when a change in the variable driving frequency corresponds to a frequency difference that is greater than or equal to a threshold frequency difference.

In an embodiment, the controller includes an emission off compensation circuit configured to calculate a compensation emission off length based on a current cycle number of an nth frame, where n is a positive integer greater than or equal to 2, a cycle differential driving determination circuit configured to generate a first output signal based on the current cycle number and a previous cycle number of an n−1^{th} frame, and an emission off length output circuit configured to output the compensation emission off length as a current emission off length of a current cycle of the emission signal to the emission driver when the first output signal has a deactivation value.

In an embodiment, the emission off length output circuit outputs a reference emission off length of the emission signal as the current emission off length to the emission driver when the first output signal has an activation value.

In an embodiment, the emission off length output circuit outputs a previous emission off length of a previous cycle prior to the current cycle as the current emission off length to the emission driver when the first output signal has an activation value.

In an embodiment, the cycle differential driving determination circuit includes a frequency difference calculator configured to calculate a difference value obtained by subtracting the previous cycle number from the current cycle number, and a frequency difference comparator configured to output a deactivation value when the difference value is less than a threshold value corresponding to the threshold frequency difference, and output an activation value when the difference value is greater than or equal to the threshold value.

In an embodiment, the cycle differential driving determination circuit further includes a storage configured to store the previous cycle number at a start of the nth frame.

In an embodiment, the cycle differential driving determination circuit further includes a first logic gate configured to generate a third output signal based on a frequency difference determination enable signal and a second output signal of the frequency difference comparator.

In an embodiment, the first logic gate is an AND gate.

In an embodiment, the cycle differential driving determination circuit further includes a second logic gate configured to generate the first output signal based on a cycle differential driving bypass signal and the third output signal.

In an embodiment, the second logic gate is an OR gate.

In an embodiment, the cycle differential driving determination circuit includes a frequency difference calculator configured to calculate a difference value obtained by subtracting the previous cycle number from the current cycle number, and a frequency difference comparator configured to output a deactivation value or an activation value based on the difference value, a threshold value corresponding to the threshold frequency difference, and a frequency direction signal.

In an embodiment, the frequency difference comparator outputs the deactivation value when the frequency direction signal has a first value and the difference value is less than the threshold value, and outputs the activation value when the frequency direction signal has the first value and the difference value is greater than or equal to the threshold value.

In an embodiment, the frequency difference comparator outputs the deactivation value when the frequency direction signal has a second value and the threshold value is less than the difference value, and outputs the activation value when the frequency direction signal has the second value and the threshold value is greater than or equal to the difference value.

In an embodiment, each of the plurality of pixels includes a light-emitting element, a driving transistor configured to apply a driving current to the light-emitting element, and a bias transistor configured to apply a bias voltage to the driving transistor.

In an embodiment, when the variable driving frequency changes from a high frequency to a low frequency, a voltage level of the bias voltage in a first low-frequency frame having the low frequency is set higher than a voltage level of the bias voltage in a high-frequency frame having the high frequency.

In an embodiment, when the driving frequency changes from the high frequency to the low frequency, a voltage level of the bias voltage in a second low-frequency frame having the low frequency is set lower than the voltage level of the bias voltage in the first low-frequency frame and higher than the voltage level of the bias voltage in the high-frequency frame.

According to an embodiment of the present disclosure, a method of driving a display device includes storing a previous cycle number of an n−1^{th} frame at a start of an nth frame, where n is a positive integer greater than or equal to 2, comparing a current cycle number of the nth frame with the previous cycle number, performing a cycle differential driving operation in which lengths of emission periods gradually increase in a frame when a value obtained by subtracting the previous cycle number from the current cycle number is less than a threshold value, and omitting the cycle differential driving operation when the value obtained by subtracting the previous cycle number from the current cycle number is greater than or equal to the threshold value.

In an embodiment, performing the cycle differential driving operation includes generating an emission signal based on a compensation emission off length calculated based on the current cycle number.

In an embodiment, the omitting the cycle differential driving includes generating an emission signal based on a reference emission off length of the emission signal or a previous emission off length of a previous cycle prior to the current cycle.

According to an embodiment of the present disclosure, an electronic apparatus includes a display panel including a plurality of pixels, which is configured to display an image at a variable driving frequency, an emission driver configured to provide an emission signal to the plurality of pixels, a controller configured to perform a cycle differential driving operation in which lengths of emission periods defined by the emission signal gradually increase in a frame, and a processor configured to provide image data to the controller. The controller omits the cycle differential driving operation when aa change in the variable driving frequency corresponds to a frequency difference that is greater than or equal to a threshold frequency difference.

In the display device, the method of driving the display device, and the electronic apparatus according to the embodiment, the cycle differential driving in which the lengths of the emission periods gradually increase is omitted when the frequency difference at the change in the driving frequency is greater than or equal to the threshold frequency difference, so that the luminance deviation of the display panel at the change in the driving frequency may decrease, and the user may be prevented from being recognize the flicker.

### BRIEF DESCRIPTION OF THE DRAWINGS

The above and other features of the present disclosure will become more apparent by describing in detail embodiments thereof with reference to the accompanying drawings.

FIG. 1 is a block diagram showing a display device according to an embodiment.

FIG. 2 is a view showing frames according to a driving frequency of a display panel of FIG. 1.

FIG. 3 is a circuit diagram showing a pixel of FIG. 1.

FIG. 4 is a view showing periods according to the driving frequency of the display panel of FIG. 1.

FIG. 5 is a timing diagram showing signals input to the pixel of FIG. 3 in a writing period.

FIG. 6 is a timing diagram showing signals input to the pixel of FIG. 3 in a holding period.

FIG. 7 is a timing diagram showing a bias voltage input to the pixel of FIG. 3.

FIG. 8 is a timing diagram showing a luminance of the display panel of FIG. 1 when cycle differential driving is not performed.

FIG. 9 is a timing diagram showing a luminance of the display panel of FIG. 1 when performing cycle differential driving.

FIG. 10 is a block diagram showing an example of a controller of FIG. 1.

FIG. 11 is a block diagram showing an example of a cycle differential driving determination block of FIG. 10.

FIG. 12 is a view showing an example of an operation of the controller of FIG. 10.

FIG. 13 is a timing diagram showing a luminance of the display panel of FIG. 1 when performing cycle differential driving at a change in the driving frequency.

FIG. 14 is a timing diagram showing a luminance of the display panel of FIG. 1 when cycle differential driving is not performed at the change in the driving frequency.

FIG. 15 is a block diagram showing an example of the controller of FIG. 1.

FIG. 16 is a view showing an example of an operation of the controller of FIG. 15.

FIG. 17 is a block diagram showing an example of the cycle differential driving determination block of FIG. 10.

FIG. 18 is a flowchart showing a method of driving a display device according to an embodiment.

FIG. 19 is a block diagram showing an electronic apparatus according to an embodiment.

FIG. 20 is a diagram illustrating an electronic device according to an embodiment of the present disclosure.

### DETAILED DESCRIPTION OF THE EMBODIMENTS

Hereinafter, a display device, a method of driving a display device, and an electronic apparatus according to embodiments of the present disclosure will be described in more detail with reference to the accompanying drawings. The same or similar reference numerals will be used for the same elements in the accompanying drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

It will be understood that when a component is referred to as being “on”, “connected to”, “coupled to”, or “adjacent to” another component, it can be directly on, connected, coupled, or adjacent to the other component, or intervening components may be present. Other words used to describe the relationships between components should be interpreted in a like fashion.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art, for example, within +30%, 20%, 10% or 5% of the stated value. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationships between components should be interpreted in a like fashion.

Embodiments of the present disclosure may improve the performance of display devices that operate at variable refresh rates, for example, during transitions between different driving frequencies.

Referring to a comparative example, a method known as cycle differential driving (CDD) is used to compensate for luminance decreases at low frequencies. This involves gradually increasing the lengths of emission periods within a frame. However, when transitioning from a high frequency to a low frequency, the use of CDD can exacerbate luminance deviations, leading to undesirable visual artifacts such as, for example, flicker.

Embodiments of the present disclosure may address such luminance deviations by utilizing a controller that effectively omits the CDD process when the frequency difference at the change in driving frequency is greater than or equal to a predefined threshold. As a result, a display device according to embodiments of the present disclosure can significantly reduce luminance deviations during frequency transitions, thereby preventing undesirable visual artifacts such as flicker and improving the visual experience for the user. Thus, embodiments of the present disclosure may maintain image quality and manage luminance in modern variable refresh rate displays.

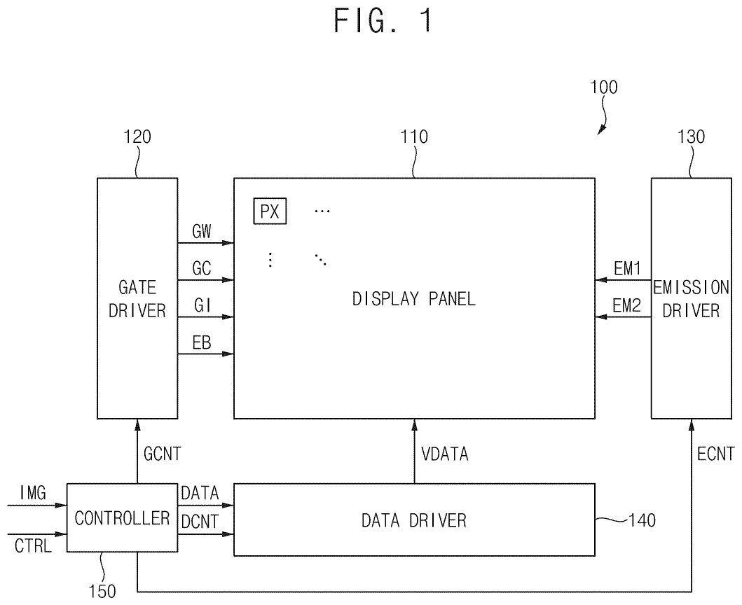

FIG. 1 is a block diagram showing a display device 100 according to an embodiment.

Referring to FIG. 1, the display device 100 may include a display panel 110, a gate driver 120, an emission driver 130, a data driver 140, and a controller 150.

The display panel 110 may display an image. The display panel 110 may include a plurality of pixels PX. Each of the pixels PX may emit light with a luminance corresponding to a data voltage VDATA in response to gate signals GW, GC, GI, and EB and emission signals EM1 and EM2.

The gate driver 120 may provide the gate signals GW, GC, GI, and EB to each of the pixels PX. The gate driver 120 may generate the gate signals GW, GC, GI, and EB based on a gate control signal GCNT. The gate signals GW, GC, GI, and EB may include a writing gate signal GW, a compensation gate signal GC, an initialization gate signal GI, and a bypass gate signal EB. The gate control signal GCNT may include, for example, a vertical synchronization signal, a gate start signal, etc.

The emission driver 130 may provide the emission signals EM1 and EM2 to each of the pixels PX. The emission driver 130 may generate the emission signals EM1 and EM2 based on an emission control signal ECNT. The emission signals EM1 and EM2 may include a first emission signal EM1 and a second emission signal EM2. The emission control signal ECNT may include, for example, the vertical synchronization signal, an emission start signal, etc.

The data driver 140 may provide the data voltage VDATA to each of the pixels PX. The data driver 140 may convert a digital data signal DATA into the analog data voltage VDATA based on a data control signal DCNT. The data control signal DCNT may include, for example, a horizontal synchronization signal, a load signal, etc.

The controller 150 may control an operation of the gate driver 120, an operation of the emission driver 130, and an operation of the data driver 140. The controller 150 may provide the gate control signal GCNT to the gate driver 120, the emission control signal ECNT to the emission driver 130, and the data signal DATA and the data control signal DCNT to the data driver 140. The controller 150 may generate the data signal DATA based on image data IMG, and may generate the gate control signal GCNT, the emission control signal ECNT, and the data control signal DCNT based on a controller control signal CTRL. For example, the image data IMG may include red image data, green image data, and blue image data. The controller control signal CTRL may include, for example, the vertical synchronization signal, the horizontal synchronization signal, a data enable signal, etc.

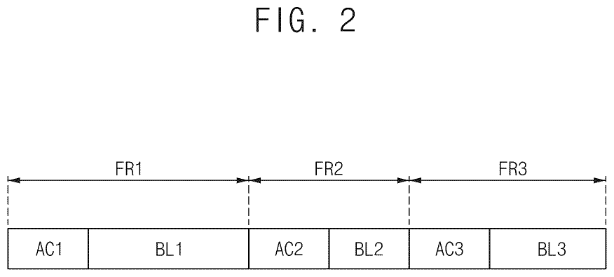

FIG. 2 is a view showing frames FR1, FR2, and FR3 according to a driving frequency of the display panel 110 of FIG. 1.

Referring to FIGS. 1 and 2, the display panel 110 may display an image at a variable driving frequency. For example, the display panel 110 may be driven by a variable refresh rate (VRR) method.

A first frame FR1 having a first frequency may include a first active period AC1 and a first blank period BL1. A second frame FR2 having a second frequency different from the first frequency may include a second active period AC2 and a second blank period BL2. A third frame FR3 having a third frequency different from the first and second frequencies may include a third active period AC3 and a third blank period BL3.

A length of the first active period AC1, a length of the second active period AC2, and a length of the third active period AC3 may be substantially equal to each other. A length of the first blank period BL1, a length of the second blank period BL2, and a length of the third blank period BL3 may be different from each other.

An operation period of the display panel 110 driven by the variable refresh rate method may include a writing period in which the data voltage VDATA is written to the pixel PX and the pixel PX emits light with a luminance corresponding to the written data voltage VDATA, and a holding period in which the data voltage VDATA is not written to the pixel PX and the pixel PX emits light with a luminance corresponding to the data voltage VDATA written in the writing period. The writing period may be arranged within the active period AC1, AC2, and AC3, and the holding period may be arranged within the blank period BL1, BL2, and BL3.

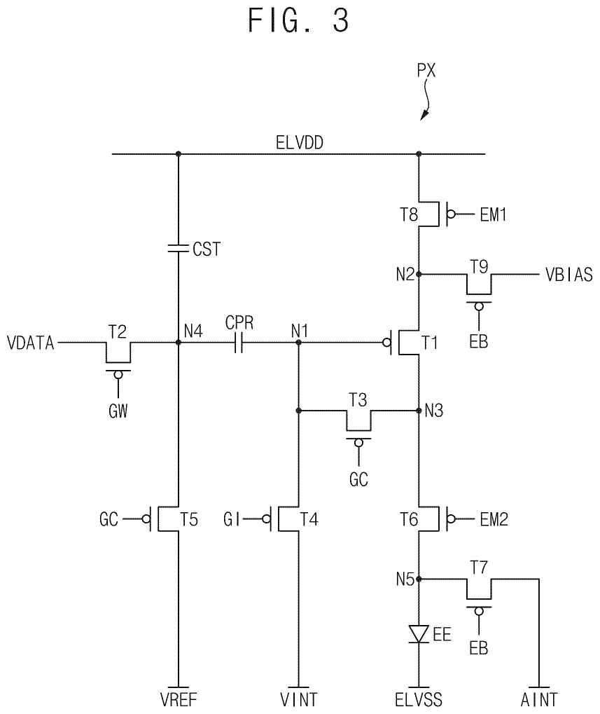

FIG. 3 is a circuit diagram showing the pixel PX of FIG. 1.

Referring to FIGS. 1 to 3, the pixel PX may include a light-emitting element EE, a driving transistor T1, a writing transistor T2, a compensation transistor T3, an initialization transistor T4, a reference transistor T5, a second emission transistor T6, a bypass transistor T7, a first emission transistor T8, a bias transistor T9, a first capacitor CST, and a second capacitor CPR.

The light-emitting element EE may include an anode connected to a fifth node N5 and a cathode that receives a low power voltage ELVSS.

The driving transistor T1 may apply a driving current to the light-emitting element EE. The driving transistor T1 may include a control electrode connected to a first node N1, a first electrode connected to a second node N2, and a second electrode connected to a third node N3.

The writing transistor T2 may include a control electrode that receives the writing gate signal GW, a first electrode that receives the data voltage VDATA, and a second electrode connected to a fourth node N4.

The compensation transistor T3 may include a control electrode that receives the compensation gate signal GC, a first electrode connected to the first node N1, and a second electrode connected to the third node N3.

The initialization transistor T4 may include a control electrode that receives the initialization gate signal GI, a first electrode that receives a first initialization voltage VINT, and a second electrode connected to the first node N1.

The reference transistor T5 may include a control electrode that receives the compensation gate signal GC, a first electrode that receives a reference voltage VREF, and a second electrode connected to the fourth node N4.

The second emission transistor T6 may include a control electrode that receives the second emission signal EM2, a first electrode connected to the third node N3, and a second electrode connected to the fifth node N5.

The bypass transistor T7 may include a control electrode that receives the bypass gate signal EB, a first electrode that receives a second initialization voltage AlNT, and a second electrode connected to the fifth node N5.

The first emission transistor T8 may include a control electrode that receives the first emission signal EM1, a first electrode that receives a high power voltage ELVDD, and a second electrode connected to the second node N2.

The bias transistor T9 may apply a bias voltage VBIAS to the driving transistor T1. The bias transistor T9 may include a control electrode that receives the bypass gate signal EB, a first electrode that receives the bias voltage VBIAS, and a second electrode connected to the second node N2.

The first capacitor CST may include a first electrode that receives the high power voltage ELVDD and a second electrode connected to the fourth node N4.

The second capacitor CPR may include a first electrode connected to the fourth node N4 and a second electrode connected to the first node N1.

For example, each of the driving transistor T1, the writing transistor T2, the compensation transistor T3, the initialization transistor T4, the reference transistor T5, the second emission transistor T6, the bypass transistor T7, the first emission transistor T8, and the bias transistor T9 may be a P-type transistor. For example, each of the driving transistor T1, the writing transistor T2, the compensation transistor T3, the initialization transistor T4, the reference transistor T5, the second emission transistor T6, the bypass transistor T7, the first emission transistor T8, and the bias transistor T9 may be a low temperature poly-silicon (LTPS) thin-film transistor.

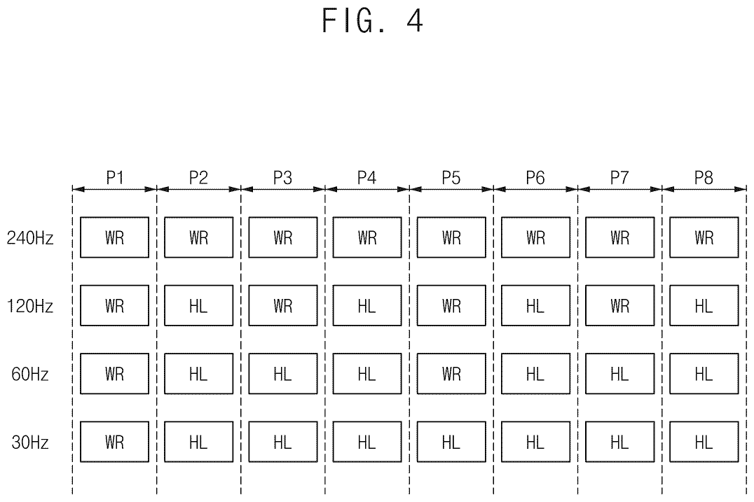

FIG. 4 is a view showing periods according to the driving frequency of the display panel 110 of FIG. 1.

Referring to FIGS. 1 to 4, the display panel 110 may be driven at a variable driving frequency. For example, when the display panel 110 displays a moving image (e.g., a video), the display panel 110 may be driven at a relatively high frequency. For example, when the display panel 110 displays a still image, the display panel 110 may be driven at a relatively low frequency.

Although FIG. 4 illustrates that the maximum driving frequency of the display panel 110 is about 240 Hz, the present disclosure is not limited thereto.

The operation period of the display panel 110 may include the writing period WR in which the data voltage VDATA is written to the control electrode of the driving transistor T1 and the light-emitting element EE emits light with a luminance corresponding to the written data voltage VDATA, and a holding period HL in which the light-emitting element EE emits light with a luminance corresponding to the data voltage VDATA written in the writing period WR without writing the data voltage VDATA to the control electrode of the driving transistor T1. In an embodiment, in the writing period WR, the writing transistor T2 may be turned on so that the data voltage VDATA may be applied to the control electrode of the driving transistor T1, and in the holding period HL, the writing transistor T2 may be turned off so that the data voltage VDATA is not be applied to the control electrode of the driving transistor T1.

Each of the first period P1 to the eighth period P8 may be one cycle. The cycle may include a non-emission period in which the light-emitting element EE does not emit light and an emission period in which the light-emitting element EE emits light.

For example, when the driving frequency of the display panel 110 is about 240 Hz, each of the first period P1 to the eighth period P8 may be the writing period WR. Each of the first period P1 to the eighth period P8 may be one frame.

For example, when the driving frequency of the display panel 110 is about 120 Hz, a ratio of the writing period WR and the holding period HL may be 1:1. For example, when the driving frequency of the display panel 110 is about 120 Hz, each of the first period P1, the third period P3, the fifth period P5, and the seventh period P7 may be the writing period WR, and each of the second period P2, the fourth period P4, the sixth period P6, and the eighth period P8 may be the holding period HL. The first period P1 and the second period P2 may form a first frame, the third period P3 and the fourth period P4 may form a second frame, the fifth period P5 and the sixth period P6 may form a third frame, and the seventh period P7 and the eighth period P8 may form a fourth frame.

For example, when the driving frequency of the display panel 110 is about 60 Hz, the ratio of the writing period WR and the holding period HL may be 1:3. For example, when the driving frequency of the display panel 110 is about 60 Hz, each of the first period P1 and the fifth period P5 may be the writing period WR, and each of the second period P2, the third period P3, the fourth period P4, the sixth period P6, the seventh period P7, and the eighth period P8 may be the holding period HL. The first period P1 to the fourth period P4 may form a first frame, and the fifth period P5 to the eighth period P8 may form a second frame.

For example, when the driving frequency of the display panel 110 is about 30 Hz, the ratio of the writing period WR and the holding period HL may be 1:7. For example, when the driving frequency of the display panel 110 is about 30 Hz, the first period P1 may be the writing period WR, and each of the second period P2, the third period P3, the fourth period P4, the fifth period P5, the sixth period P6, the seventh period P7, and the eighth period P8 may be the holding period HL. The first period P1 to the eighth period P8 may form a first frame.

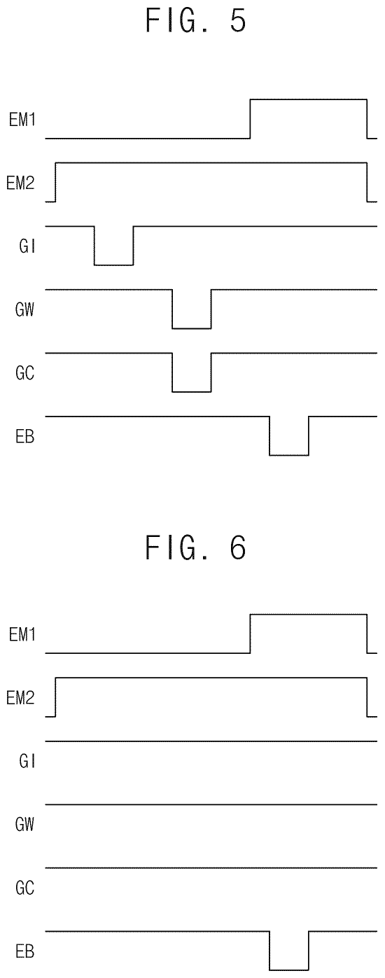

FIG. 5 is a timing diagram showing signals input to the pixel PX of FIG. 3 in the writing period WR. FIG. 6 is a timing diagram showing signals input to the pixel PX of FIG. 3 in the holding period HL.

Referring to FIGS. 1 to 6, in the writing period WR, each of the initialization gate signal GI, the writing gate signal GW, the compensation gate signal GC, and the bypass gate signal EB may have an activation pulse. The activation pulse may be a low-level pulse.

In a period in which the initialization gate signal GI has the activation pulse, the initialization transistor T4 may be turned on, and as a result, the first initialization voltage VINT may be applied to the control electrode of the driving transistor T1.

In a period in which each of the writing gate signal GW and the compensation gate signal GC has the activation pulse, the writing transistor T2 and the compensation transistor T3 may be turned on, and as a result, the data voltage VDATA for which the threshold voltage of the driving transistor T1 is compensated may be written to the control electrode of the driving transistor T1.

In a period in which the bypass gate signal EB has the activation pulse, the bypass transistor T7 may be turned on, and as a result, the second initialization voltage AlNT may be applied to the anode of the light-emitting element EE. Further, in the period in which the bypass gate signal EB has the activation pulse, the bias transistor T9 may be turned on, and as a result, the bias voltage VBIAS may be applied to the first electrode of the driving transistor T1.

In an embodiment, in the writing period WR, an initialization operation by the initialization transistor T4, a writing operation by the writing transistor T2 and the compensation transistor T3, a bypass operation by the bypass transistor T7, and a bias operation by the bias transistor T9 may be performed.

In an embodiment, in the holding period HL, each of the initialization gate signal GI, the writing gate signal GW, and the compensation gate signal GC may maintain at a deactivation level, and the bypass gate signal EB may have an activation pulse. The deactivation level may be a high level, and the activation pulse may be a low-level pulse.

In an embodiment, in the holding period HL, the initialization operation by the initialization transistor T4 and the writing operation by the writing transistor T2 and the compensation transistor T3 are not performed. However, in the holding period HL, the bypass operation by the bypass transistor T7 and the bias operation by the bias transistor T9 may be performed.

In an embodiment, in the writing period WR, in the period in which the initialization gate signal GI, the writing gate signal GW, the compensation gate signal GC, or the bypass gate signal EB has the activation pulse, the second emission signal EM2 may have a deactivation level. In the writing period WR, in the period in which the bypass gate signal EB has the activation pulse, the first emission signal EM1 may have a deactivation level. A deactivation period of the second emission signal EM2 may include a deactivation period of the first emission signal EM1.

A waveform of the first emission signal EM1 in the holding period HL may be the same as a waveform of the first emission signal EM1 in the writing period WR. Further, a waveform of the second emission signal EM2 in the holding period HL may be the same as a waveform of the second emission signal EM2 in the writing period WR.

In each cycle, the emission period may be defined by the emission signals EM1 and EM2. For example, in each cycle, the emission period may be defined as a period in which the second emission signal EM2 has an activation level, and the non-emission period may be defined as a period in which the second emission signal EM2 has the deactivation level.

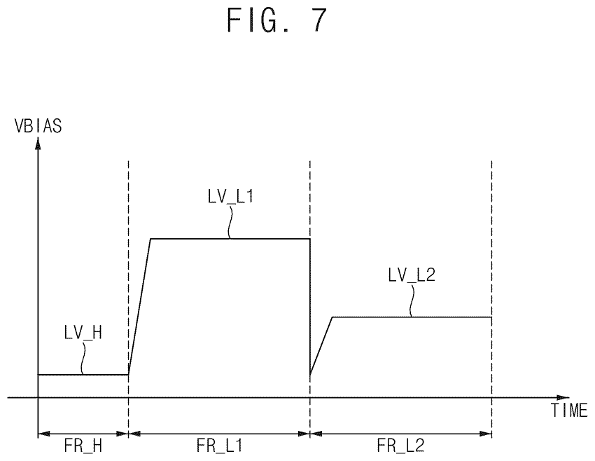

FIG. 7 is a timing diagram showing the bias voltage VBIAS input to the pixel PX of FIG. 3.

Since the hysteresis characteristics of the driving transistor T1 of the pixel PX are different in the writing period WR and the holding period HL, when the driving frequency of the display panel 110 changes from a high frequency to a low frequency, a luminance deviation of the display panel 110 may occur, and a flicker may be recognized due to the luminance deviation.

Referring to FIG. 7, when the driving frequency of the display panel 110 changes from the high frequency to the low frequency, a voltage level of the bias voltage VBIAS in a first low-frequency frame FR_L1 having the low frequency may be set higher than a voltage level LV_H of the bias voltage VBIAS in a high-frequency frame FR_H having the high frequency. For example, the voltage level of the bias voltage VBIAS in the first low-frequency frame FR_L1 may increase toward a first voltage level LV_L1.

When the data voltage VDATA corresponding to the same grayscale is written to pixels PX in frames FR_H, FR_L1, and FR_L2, a luminance in the first low-frequency frame FR_L1 may be higher than a luminance in the high-frequency frame FR_H. Accordingly, if the voltage level of the bias voltage VBIAS in the first low-frequency frame FR_L1 is set higher than the voltage level LV_H of the bias voltage VBIAS in the high-frequency frame FR_H, the luminance of the first low-frequency frame FR_L1 may decrease. Accordingly, the luminance deviation of the display panel 110 may decrease by setting the voltage level of the bias voltage VBIAS in the first low-frequency frame FR_L1 higher than the voltage level LV_H of the bias voltage VBIAS in the high-frequency frame FR_H.

For example, according to an embodiment, when the data voltage VDATA, corresponding to the same grayscale, is written to the pixels PX in frames FR_H, FR_L1, and FR_L2, the luminance in the first low-frequency frame FR_L1 may exceed the luminance in the high-frequency frame FR_H. To address this, the voltage level of the bias voltage VBIAS in the first low-frequency frame FR_L1 can be increased to a level higher than the voltage level LV_H, the voltage level of the bias voltage VBIAS in the high-frequency frame FR_H. This adjustment may reduce the luminance in the first low-frequency frame FR_L1, thereby decreasing the luminance deviation of the display panel 110. As a result, setting the bias voltage VBIAS in the first low-frequency frame FR_L1 to a higher level than in the high-frequency frame FR_H may mitigate luminance variations between frames.

When the driving frequency of the display panel 110 changes from the high frequency to the low frequency, a voltage level of the bias voltage VBIAS in the second low-frequency frame FR_L2 having the low frequency may be set lower than the voltage level of the bias voltage VBIAS in the first low-frequency frame FR_L1 and higher than the voltage level of the bias voltage VBIAS in the high-frequency frame FR_H. For example, the voltage level of the bias voltage VBIAS in the second low-frequency frame FR_L2 may increase toward a second voltage level LV_L2 lower than the first voltage level LV_L1.

For example, according to an embodiment, when the driving frequency of the display panel 110 transitions from a high frequency to a low frequency, the voltage level of the bias voltage VBIAS in the second low-frequency frame FR_L2, operating at the low frequency, may be set lower than the voltage level of the bias voltage VBIAS in the first low-frequency frame FR_L1 but higher than the voltage level of the bias voltage VBIAS in the high-frequency frame FR_H. For example, the voltage level of the bias voltage VBIAS in the second low-frequency frame FR_L2 may increase toward a second voltage level LV_L2, which is lower than the first voltage level LV_L1.

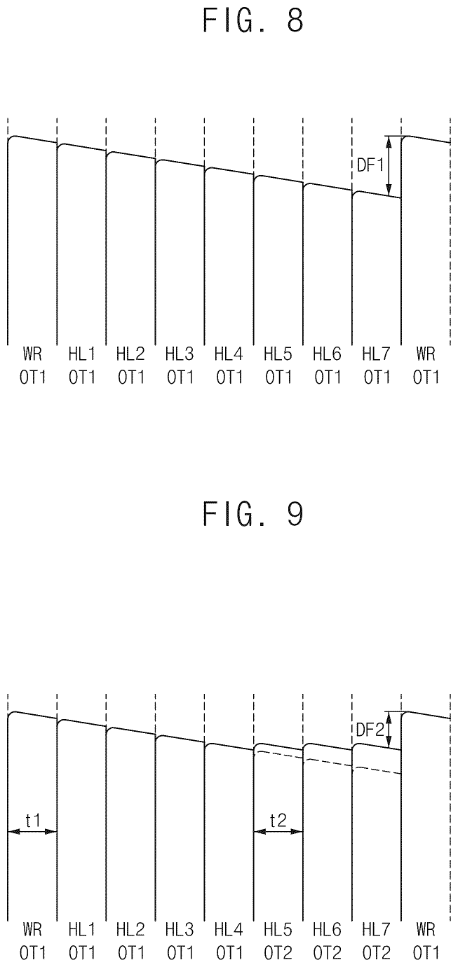

FIG. 8 is a timing diagram showing a luminance of the display panel 110 of FIG. 1 when cycle differential driving is not performed.

In FIG. 8, WR denotes the writing period, and each of HL1 to HL7 denote the holding period. During low-frequency driving, as illustrated in FIG. 8, the operation period of the display panel 110 may include one writing period and a plurality of holding periods.

During low-frequency driving, when the holding periods continue, a luminance of the display panel 110 may decrease. In FIG. 8, when the seventh holding period HL7 is the last holding period of a first frame, a luminance difference between a luminance of the seventh holding period HL7 and a luminance of the writing period WR of a second frame may be represented as DF1. The luminance difference DF1 may be recognized as flicker by the user.

FIG. 9 is a timing diagram showing a luminance of the display panel 110 of FIG. 1 when performing the cycle differential driving.

To improve the flicker due to the luminance difference DF1, as illustrated in FIG. 9, the controller 150 may perform the cycle differential driving (CDD) in which lengths of the emission periods in one frame gradually increase. For example, in the writing period WR and the first holding period HL1 to the fourth holding period HL4, the length of the emission period in each cycle may be a first emission time duration OT1. Further, in the fifth holding period HL5 to the seventh holding period HL7, the length of the emission period in each cycle may be a second emission time duration OT2.

When the lengths of the emission periods in one frame gradually increase, a luminance of each cycle (e.g., HL5 to HL7) in which the length of the emission period increases may increase.

In FIG. 9, when the seventh holding period HL7 is the last holding period of the first frame, a luminance difference between a luminance of the seventh holding period HL7 and a luminance of the writing period WR of the second frame may be represented as DF2. The luminance difference DF2 when performing cycle differential driving may be less than the luminance difference DF1 when the cycle differential driving is not performed, and thus, the flicker due to the luminance difference DF2 may be improved.

For example, according to an embodiment, to address flicker caused by the luminance difference DF1, as shown in FIG. 9, the controller 150 may implement CDD. This may involve gradually increasing the lengths of the emission periods within a single frame. For example, during the writing period WR and the first through fourth holding periods (e.g., HL1 to HL4), the emission period length for each cycle may correspond to a first emission time duration OT1. Subsequently, during the fifth through seventh holding periods (e.g., HL5 to HL7), the emission period length for each cycle may correspond to a second emission time duration OT2, which is longer than OT1.

By gradually increasing the lengths of the emission periods within a frame, the luminance of cycles with extended emission periods (e.g., HL5 to HL7) may also increase. This progressive adjustment can help in compensating for luminance losses that occur during extended holding periods at lower frequencies.

Still referring to FIG. 9, when the seventh holding period HL7 represents the final holding period of the first frame, the luminance difference between HL7 and the writing period WR of the subsequent frame can be expressed as DF2. When CDD is utilized, the luminance difference DF2 is smaller than the luminance difference DF1, which occurs without CDD. As a result, the implementation of CDD may effectively reduce flicker associated with luminance variations and improve the viewing experience.

In FIG. 9, the cycles (e.g., WR, HL1, HL2, HL3, and HL4) having the first emission time duration OT1 may have a first time duration t1, and the cycles (e.g., HL5, HL6, and HL7) having the second emission time duration OT2 may have a second duration t2. The second duration t2 may be greater than the first duration t1.

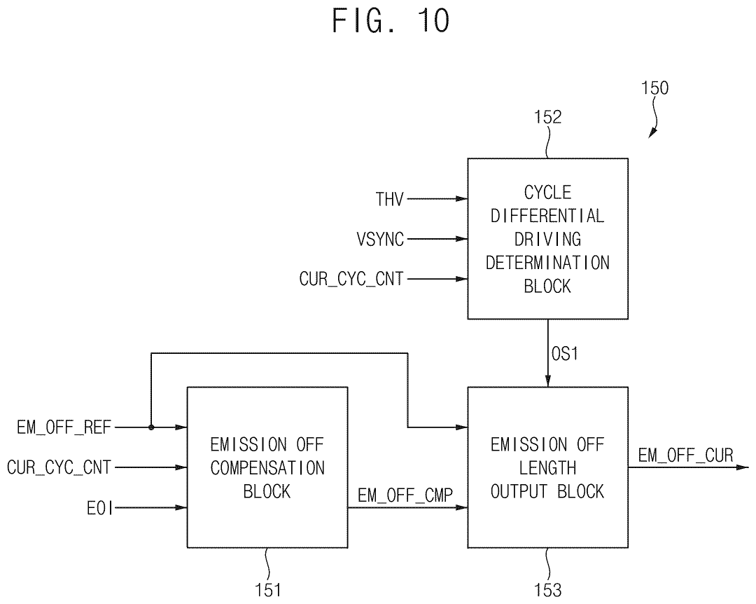

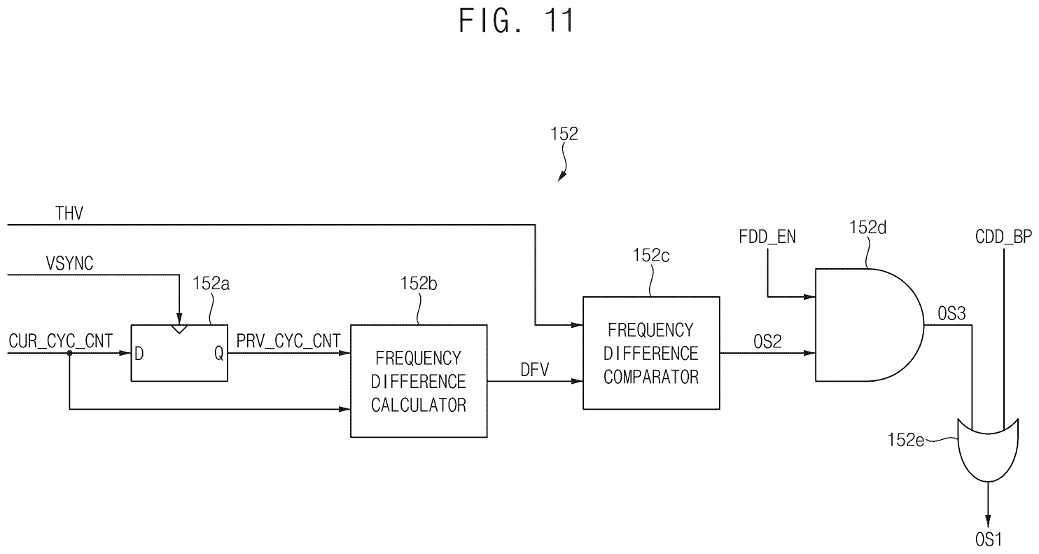

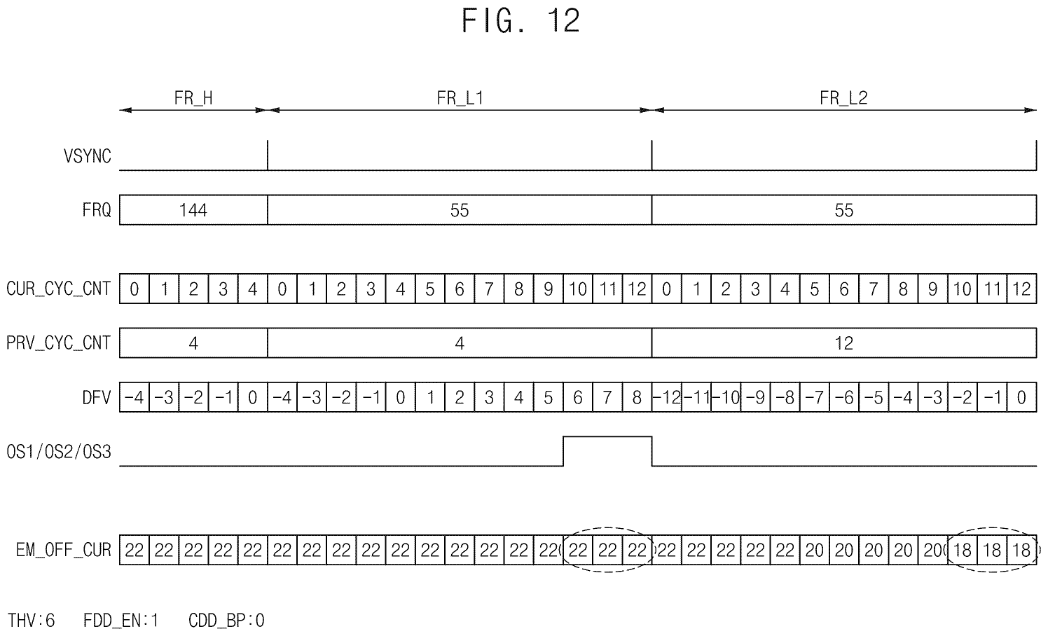

FIG. 10 is a block diagram showing an example of the controller 150 of FIG. 1. FIG. 11 is a block diagram showing an example of a cycle differential driving determination block 152 of FIG. 10. FIG. 12 is a view showing an example of an operation of the controller 150 of FIG. 10.

In FIG. 12, FR_H represents a high-frequency frame having a driving frequency FRQ of about 144 Hz, and FR_L1 and FR_L2 represent a first low-frequency frame and a second low-frequency frame having a driving frequency of about 55 Hz, respectively. The driving frequency of the display panel 110 may change from a high frequency to a low frequency between the high-frequency frame FR_H and the first low-frequency frame FR_L1. The high-frequency frame FR_H may include 5 cycles, and the low-frequency frames FR_L1 and FR_L2 may include 13 cycles.

Referring to FIGS. 1 to 12, the controller 150 may perform cycle differential driving when a frequency difference during a change in the driving frequency of the display panel 110 is less than a threshold frequency difference, and may omit cycle differential driving when the frequency difference during the change in the driving frequency of the display panel 110 is greater than or equal to the threshold frequency difference. For example, in an embodiment, the controller 150 may perform a cycle differential driving operation when a change in the variable driving frequency results in a frequency difference that is less than the threshold frequency difference, and may omit the cycle differential driving operation when a change in the variable driving frequency results in a frequency difference that is greater than or equal to the threshold frequency difference. For example, in an embodiment, the controller 150 may omit the cycle differential driving operation when a difference between a prior driving frequency and a subsequent driving frequency during a change exceeds or equals the threshold frequency difference. That is, in an embodiment, the controller 150 may omit the cycle differential driving operation when a change in the variable driving frequency corresponds to a frequency difference greater than or equal to the threshold frequency difference. The controller 150 may include an emission off compensation block 151 (also referred to as an emission off compensation circuit), a cycle differential driving determination block 152 (also referred to as a cycle differential driving determination circuit), and an emission off length output block 153 (also referred to as an emission off length output circuit).

The emission off compensation block 151 may calculate a compensation emission off length EM_OFF_CMP based on a current cycle number CUR_CYC_CNT of an nth frame, where n is a positive integer greater than or equal to 2. The emission off compensation block 151 may calculate a compensation emission off offset corresponding to the current cycle number CUR_CYC_CNT based on emission off information EOI for compensation emission off offsets corresponding to cycle numbers, and may calculate the compensation emission off length EM_OFF_CMP by adding the compensation emission off offset to a reference emission off length EM_OFF_REF. The emission off information EOI may be stored in the form of a look-up table LUT. For example, the reference emission off length EM_OFF_REF may be 22, the compensation emission off offset may be 0, and the compensation emission off length EM_OFF_CMP may be 22 in first to fifth cycles of one frame, the compensation emission off offset may be −2 and the compensation emission off length EM_OFF_CMP may be 20 in sixth to tenth cycles of one frame, and the compensation emission off offset may be −4 and the compensation emission off length EM_OFF_CMP may be 18 in eleventh to thirteenth cycles of one frame. For example, a unit of each of the compensation emission off length EM_OFF_CMP and the reference emission off length EM_OFF_REF may be a horizontal time duration.

The cycle differential driving determination block 152 may generate a first output signal OS1 based on the current cycle number CUR_CYC_CNT of the nth frame and a previous cycle number PRV_CYC_CNT of an n−1^{th} frame. The cycle differential driving determination block 152 may include a storage 152a, a frequency difference calculator 152b (also referred to as a frequency difference calculator circuit), a frequency difference comparator 152c (also referred to as a frequency difference comparator circuit), a first logic gate 152d, and a second logic gate 152e.

The storage 152a may store the previous cycle number PRV_CYC_CNT of the n−1^{th} frame at the start of the nth frame. The storage 152a may store the current cycle number CUR_CYC_CNT of the previous frame as the previous cycle number PRV_CYC_CNT in response to a pulse of a vertical synchronization signal VSYNC. For example, as illustrated in FIG. 12, the storage 152a may store the current cycle number CUR_CYC_CNT of the high-frequency frame FR_H, which is 4, as the previous cycle number PRV_CYC_CNT of the first low-frequency frame FR_L1 in response to a pulse of the vertical synchronization signal VSYNC between the high-frequency frame FR_H and the first low-frequency frame FR_L1, and may store the current cycle number CUR_CYC_CNT of the first low-frequency frame FR_L1, which is 12, as the previous cycle number PRV_CYC_CNT of the second low-frequency frame FR_L2 in response to a pulse of the vertical synchronization signal VSYNC between the first low-frequency frame FR_L1 and the second low-frequency frame FR_L2.

The frequency difference calculator 152b may calculate a difference value DFV, which is obtained by subtracting the previous cycle number PRV_CYC_CNT from the current cycle number CUR_CYC_CNT. For example, as illustrated in FIG. 12, the frequency difference calculator 152b may calculate the difference value DFV for each cycle.

The frequency difference comparator 152c may compare the difference value DFV and a threshold value THV to generate a second output signal OS2. The frequency difference comparator 152c may output the second output signal OS2 having a deactivation value (e.g., 0) when the difference value DFV is less than the threshold value THV, and may output the second output signal OS2 having an activation value (e.g., 1) when the difference value DFV is greater than or equal to the threshold value THV. The threshold value THV may correspond to the threshold frequency difference. For example, as illustrated in FIG. 12, the frequency difference calculator 152b may output the deactivation value in entire cycles of the high-frequency frame FR_H, first to tenth cycles of the first low-frequency frame FR_L1, and entire cycles of the second low-frequency frame FR_L2 in which the difference value DFV is less than the threshold value THV, and may output the activation value in eleventh to thirteenth cycles of the first low-frequency frame FR_L1 in which the difference value DFV of the first low-frequency frame FR_L1 is greater than or equal to the threshold value THV. For example, the threshold value THV may be stored in a register.

The first logic gate 152d may generate a third output signal OS3 based on a frequency difference determination enable signal FDD_EN and the second output signal OS2. In an embodiment, the first logic gate 152d may be an AND gate. In this case, the first logic gate 152d may output an activation value when the frequency difference determination enable signal FDD_EN and the second output signal OS2 have activation values, and may output a deactivation value when the frequency difference determination enable signal FDD_EN or the second output signal OS2 has a deactivation value. Even if the second output signal OS2 has the activation value, the first logic gate 152d may output the deactivation value when the frequency difference determination enable signal FDD_EN has the deactivation value. For example, the frequency difference determination enable signal FDD_EN may be stored in a register.

The second logic gate 152e may generate the first output signal OS1 based on a cycle differential driving bypass signal CDD_BP and the third output signal OS3. In an embodiment, the second logic gate 152e may be an OR gate. In this case, the second logic gate 152e may output an activation value when the cycle differential drive bypass signal CDD_BP or the third output signal OS3 has an activation value, and may output a deactivation value when the cycle differential drive bypass signal CDD_BP and the third output signal OS3 have deactivation values. When the third output signal OS3 has the activation value regardless of the cycle differential drive bypass signal CDD_BP, the second logic gate 152e may output the activation value. For example, the cycle differential drive bypass signal CDD_BP may be stored in a register.

The emission off length output block 153 may output the compensation emission off length EM_OFF_CMP as a current emission off length EM_OFF_CUR of a current cycle of the emission signal EM1 and EM2 to the emission driver 130 when the first output signal OS1 has the deactivation value.

In an embodiment, the emission off length output block 153 may output the reference emission off length EM_OFF_REF as the current emission off length EM_OFF_CUR of the current cycle of the emission signal EM1 and EM2 to the emission driver 130 when the first output signal OS1 has the activation value. For example, as illustrated in FIG. 12, the emission off length output block 153 may output the compensation emission off length EM_OFF_CMP as the current emission off length EM_OFF_CUR when the first output signal OS1 has the deactivation value (e.g., 0), and may output the reference emission off length EM_OFF_REF as the current emission off length EM_OFF_CUR when the first output signal OS1 has the activation value (e.g., 1).

FIG. 13 is a timing diagram showing a luminance of the display panel 110 of FIG. 1 when performing cycle differential driving at the change in the driving frequency.

As illustrated in FIG. 13, when the driving frequency of the display panel 110 changes from a high frequency (e.g., about 240 Hz) to a low frequency (e.g., about 30 Hz), even if the voltage level of the bias voltage VBIAS of the first low-frequency frame is set higher than the voltage level of the bias voltage VBIAS of the high-frequency frame, the luminance LUM of the display panel 110 may increase in the first low-frequency frame when performing cycle differential driving. Accordingly, the luminance LUM of the first low-frequency frame may be higher than the luminance LUM of the high-frequency frame, and a luminance deviation of the display panel 110 may occur between the first low-frequency frame and the high-frequency frame.

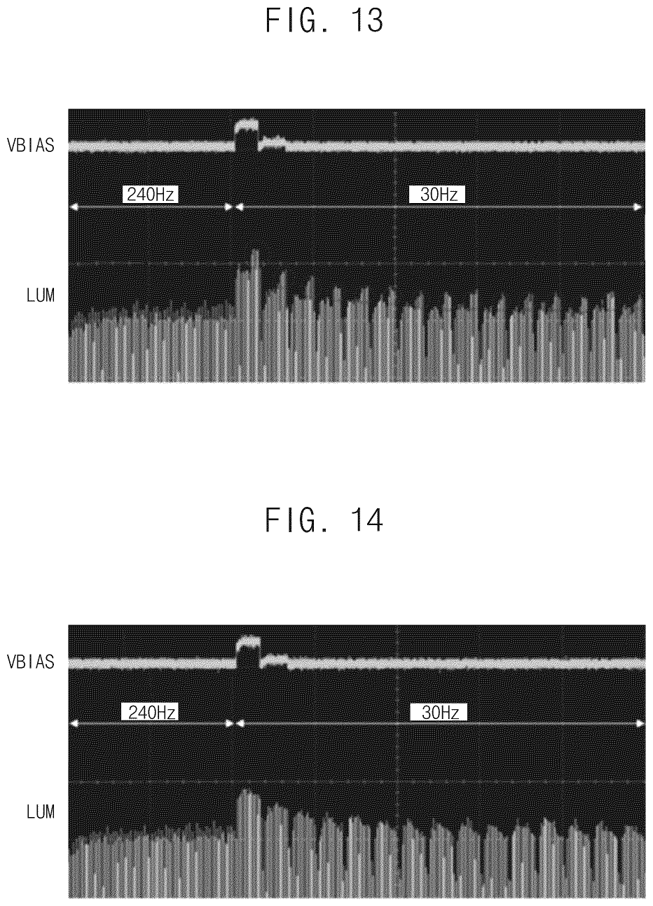

FIG. 14 is a timing diagram showing a luminance of the display panel 110 of FIG. 1 when cycle differential driving at the change in the driving frequency is not performed.

As illustrated in FIG. 14, when the driving frequency of the display panel 110 changes from the high frequency (e.g., about 240 Hz) to the low frequency (e.g., about 30 Hz), the voltage level of the bias voltage VBIAS of the first low-frequency frame is set higher than the voltage level of the bias voltage VBIAS of the high-frequency frame, and the cycle differential driving is not performed. As a result, the luminance LUM of the display panel 110 in the first low-frequency frame may decrease. Accordingly, the luminance deviation of the display panel 110 between the first low-frequency frame and the high-frequency frame when the cycle differential driving is not performed may be less than the luminance deviation of the display panel 110 between the first low-frequency frame and the high-frequency frame when the cycle differential driving is performed, and the flicker due to the luminance deviation may be improved (e.g., reduced or eliminated).

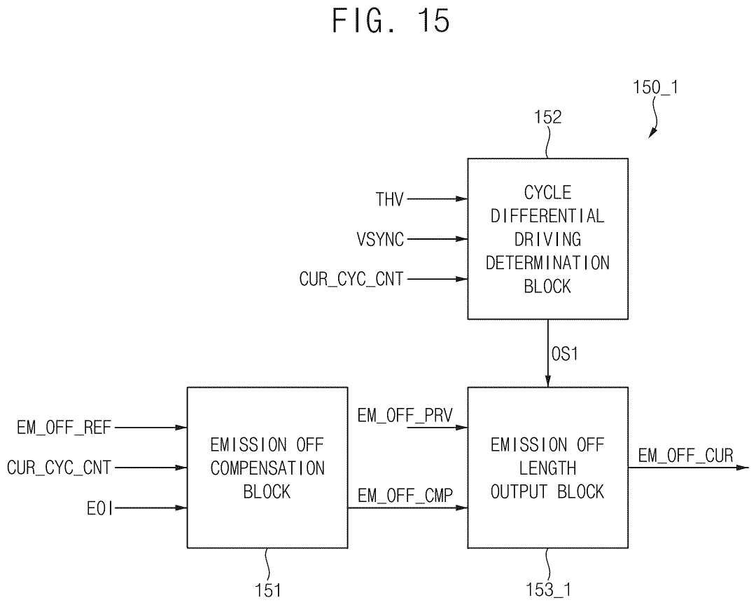

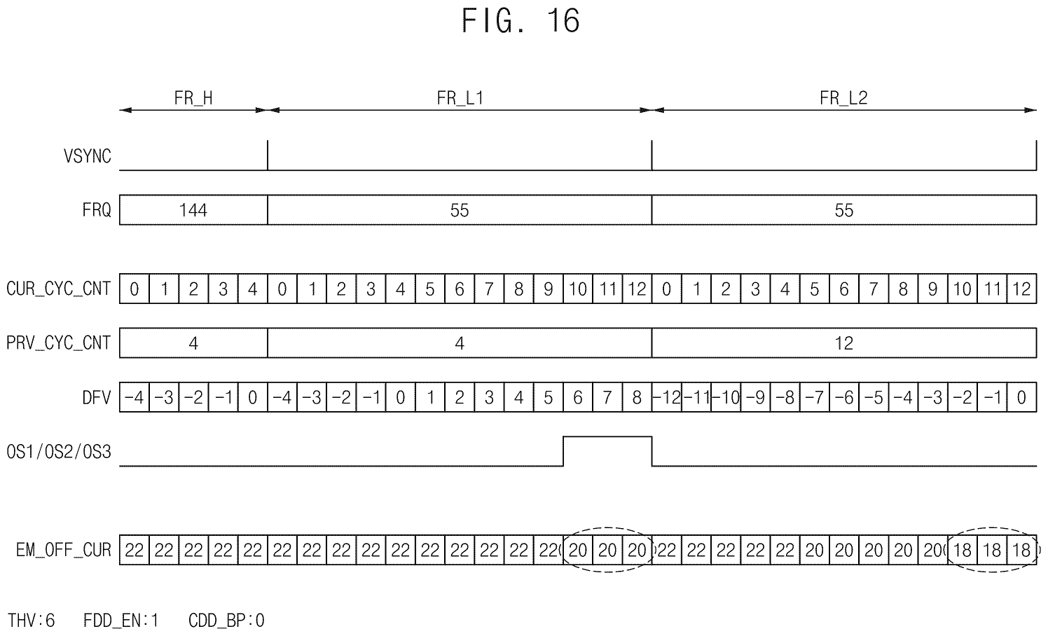

FIG. 15 is a block diagram showing an example of the controller 150 of FIG. 1, denoted by 150_1 in FIG. 15. FIG. 16 is a view showing an example of an operation of the controller 150_1 of FIG. 15.

For convenience of explanation, a further description of components, operations, and technical aspects previously described with reference to FIGS. 15 and 16, which are substantially the same as or similar to those of the controller 150 described with reference to FIGS. 10 to 12, are omitted.

Referring to FIGS. 15 and 16, the controller 150_1 may include an emission off compensation block 151, a cycle differential driving determination block 152, and an emission off length output block 153_1.

In an embodiment, the emission off length output block 153_1 may output a previous emission off length EM_OFF_PRV of a previous cycle prior to the current cycle as the current emission off length EM_OFF_CUR of the current cycle of the emission signal EM1 and EM2 to the emission driver 130 when the first output signal OS1 has the activation value. For example, as illustrated in FIG. 16, the emission off length output block 153_1 may output 20, which is the emission off length of a tenth cycle prior to an eleventh cycle, as the current emission off length EM_OFF_CUR in eleventh to thirteenth cycles of the first low-frequency frame FR_L1 in which the first output signal OS1 has the activation value. For example, a unit of the previous emission off length EM_OFF_PRV may be a horizontal time duration.

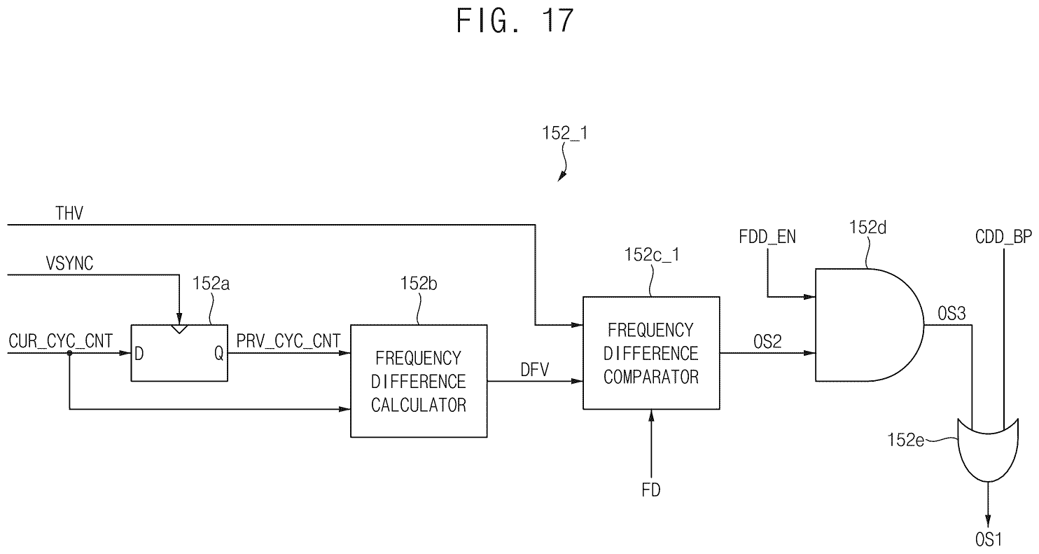

FIG. 17 is a block diagram showing an example of the cycle differential driving determination block 152 of FIG. 10, denoted by 152_1 in FIG. 17.

For convenience of explanation, a further description of components, operations, and technical aspects of the cycle differential driving determination block 152_1 described with reference to FIG. 17, which are substantially the same as or similar to those of the cycle differential driving determination block 152 described with reference to FIG. 11, are omitted.

The cycle differential driving determination block 152_1 may include a storage 152a, a frequency difference calculator 152b, a frequency difference comparator 152c_1, a first logic gate 152d, and a second logic gate 152e.

The frequency difference comparator 152c_1 may generate a second output signal OS2 having a deactivation value or an activation value based on a difference value DFV, a threshold value THV, and a frequency direction signal FD.

The frequency difference comparator 152c_1 may output the second output signal OS2 having the deactivation value (e.g., 0) when the frequency direction signal FD has a first value (e.g., 0) and the difference value DFV is less than the threshold value THV, and may output the second output signal OS2 having the activation value (e.g., 1) when the frequency direction signal FD has the first value and the difference value DFV is greater than or equal to the threshold value THV. When the frequency direction signal FD has the first value, the frequency difference comparator 152c_1 may output the second output signal OS2 having the activation value when the driving frequency of the display panel 110 changes from a high frequency to a low frequency and the frequency difference is greater than or equal to the threshold frequency difference.

The frequency difference comparator 152c_1 may output the second output signal OS2 having the deactivation value when the frequency direction signal FD has a second value (e.g., 1) and the threshold value THV is less than the difference value DFV, and may output the second output signal OS2 having the activation value when the frequency direction signal FD has the second value and the threshold value THV is greater than or equal to the difference value DFV. When the frequency direction signal FD has the second value, the frequency difference comparator 152c_1 may output the second output signal OS2 having the activation value when the driving frequency of the display panel 110 changes from a low frequency to a high frequency and the frequency difference is greater than or equal to the threshold frequency difference.

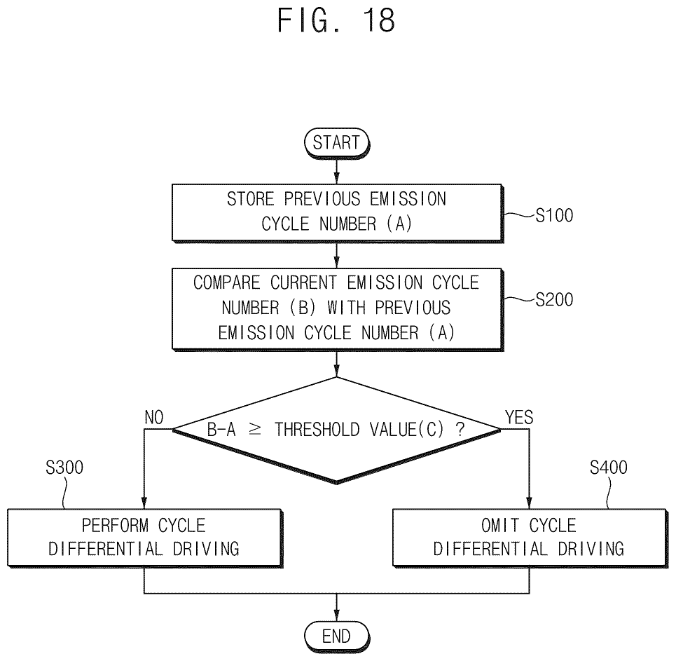

FIG. 18 is a flowchart showing a method of driving a display device 100 according to an embodiment.

Referring to FIGS. 1 to 18, in a method of driving the display device 100, the controller 150 and 150_1 may store the previous cycle number PRV_CYC_CNT of the n−1^{th} frame at the start of the nth frame (S100), may compare the current cycle number CUR_CYC_CNT of the nth frame with the previous cycle number PRV_CYC_CNT of the n−1^{th} frame (S200), may perform cycle differential driving in which the lengths of the emission periods in one frame gradually increase when the value obtained by subtracting the previous cycle number PRV_CYC_CNT from the current cycle number CUR_CYC_CNT is less than the threshold value THV (S300), and may omit the cycle differential driving when the value obtained by subtracting the previous cycle number PRV_CYC_CNT from the current cycle number CUR_CYC_CNT is greater than or equal to the threshold value THV (S400). For example, in an embodiment, a change in the variable driving frequency is represented by the difference between the current cycle number CUR_CYC_CNT and the previous cycle number PRV_CYC_CNT. The threshold value THV corresponds to a threshold frequency difference, which determines whether the change in the variable driving frequency is significant enough to omit the cycle differential driving operation. When the frequency difference, as calculated by this subtraction, is greater than or equal to the threshold value THV, the controller 150 and 150_1 recognizes the change as substantial and omits the cycle differential driving operation, which may reduce luminance deviations and prevent or reduce flicker.

When the controller 150 and 150_1 performs cycle differential driving (S300), the emission driver 130 may generate the emission signal EM1 and EM2 based on the compensation emission off length EM_OFF_CMP calculated based on the current cycle number CUR_CYC_CNT. When the controller 150 and 150_1 omits cycle differential driving (S400), the emission driver 130 may generate the emission signal EM1 and EM2 based on the reference emission off length EM_OFF_REF or the previous emission off length EM_OFF_PRV of the previous cycle prior to the current cycle.

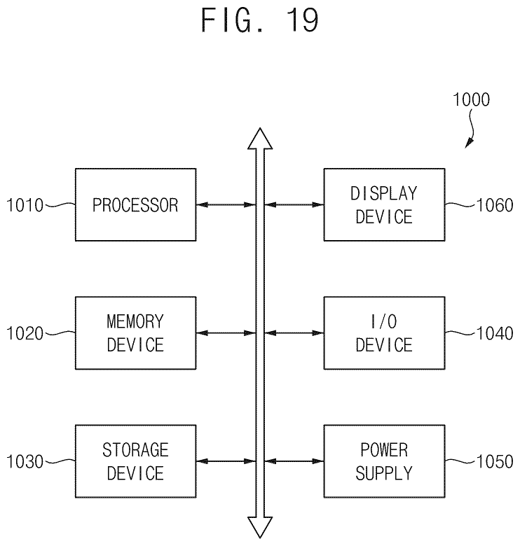

FIG. 19 is a block diagram showing an electronic apparatus 1000 according to an embodiment.

Referring to FIG. 19, the electronic apparatus 1000 may include a processor 1010, a memory device 1020, a storage device 1030, an input/output (I/O) device 1040, a power supply 1050, and a display device 1060. The electronic apparatus 1000 may further include a plurality of ports capable of communicating with, for example, a video card, a sound card, a memory card, a USB device, etc., or communicating with other systems.

The processor 1010 may perform specific calculations or tasks. According to an embodiment, the processor 1010 may be, for example, a microprocessor, a central processing unit (CPU), etc. The processor 1010 may be connected to other components through, for example, an address bus, a control bus, a data bus, etc. According to an embodiment, the processor 1010 may also be connected to an expansion bus such as a peripheral component interconnect (PCI) bus. In an embodiment, the processor 1010 may provide the image data IMG of FIG. 1 and the controller control signal CTRL of FIG. 1 to the display device 1060.

The memory device 1020 may store data utilized for an operation of the electronic apparatus 1000. For example, the memory device 1020 may include a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM), and/or a volatile memory device such as a dynamic random access memory (DRAM), a static random access memory (SRAM), or a mobile DRAM.

The storage device 1030 may include, for example, a solid state drive (SSD), a hard disk drive (HDD), a CD-ROM, etc. The I/O device 1040 may include, for example, an input device such as a keyboard, a keypad, a touch pad, a touch screen, or a mouse, and/or an output device such as a speaker or a printer. The power supply 1050 may supply power utilized for the operation of the electronic apparatus 1000. The display device 1060 may be connected to other components through the buses or other communication links. The display device 1060 may correspond to the display device 100 of FIG. 1.

The display device according to embodiments may be applied to a display device included in, for example, a computer, a notebook, a mobile phone, a smartphone, a smart pad, a smart watch, a PMP, a PDA, an MP3 player, etc.

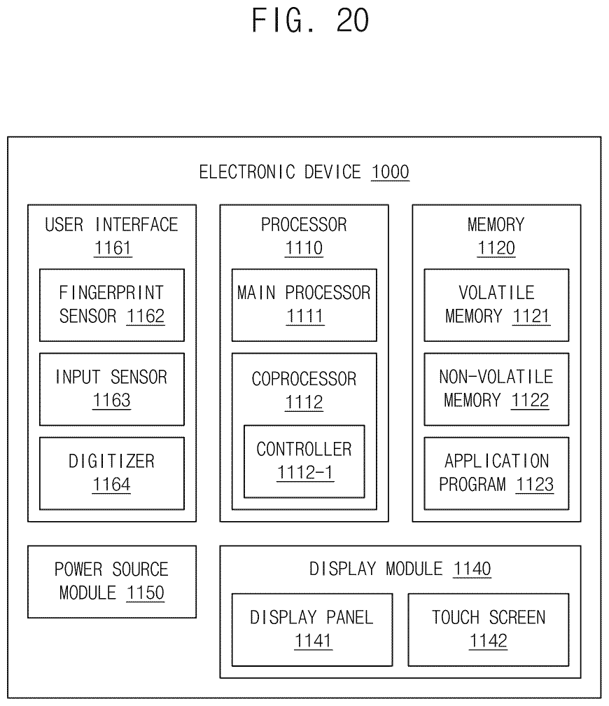

FIG. 20 is a diagram illustrating an electronic device according to an embodiment of the present disclosure.

Referring to FIG. 20, the electronic device 1000 may be the electronic apparatus 1000 of FIG. 19 including additional components. The electronic device 1000 according to an embodiment of the present disclosure may output various information (e.g., images, text, music, etc.) through a display module 1140, which, for example, may correspond to the display device 100 shown in FIG. 1. When a processor 1110 executes an application stored in a memory 1120, the display module 1140 may provide application information to a user through a display panel 1141.

In some embodiments, the electronic device 1000 may be configured as, for example, a smartphone, camera, smart TV, monitor, smartwatch, tablet, automotive display, or AR/VR headset. For example, the electronic device 1000 may be a smartphone including a touch-sensitive display area DA for interaction and a non-display area NDA including sensors and circuits for enhanced functionality. For example, the electronic device 1000 may be a television or monitor including a large display area DA for high-resolution video playback and a non-display area NDA incorporating driving circuits or connectivity modules for external inputs. For example, the electronic device 1000 may be a smartwatch including a display area DA optimized for compact and high-clarity visuals and a non-display area NDA integrating biometric sensors for health monitoring. In some cases, the electronic device 1000 be an AR/VR headset.

In some embodiments, memory 1120 may store information such as software codes for operating an application program 1123. The application program 1123 may include software designed to execute specific tasks or provide functionality to a user. The application program 1123 may operate under the control of the processor 1110 and utilizes data stored in the memory 1120 to deliver a wide range of features, such as, for example, productivity tools, multimedia streaming and playback, file or mail deliveries or communication services. The application program 1123 interacts seamlessly with the user interface 1161 or touch screen 1142, allowing a user to launch, navigate, and utilize the program through user inputs such as, for example, touch, tap, gesture, or voice interaction.

Upon user selection of an application via touch screen 1142 or user interface 1161, the processor 1110 may execute the application program 1123 corresponding to the selected application retrieved from the memory 1120 to perform functionalities of the application. For example, when a user selects a camera application by tapping the icon (or a camera application icon) presented on the display panel 1141, the processor 1110 activates a camera module. The processor 1110 may transmit image data corresponding to a captured image acquired through the camera module to the display module 1140. The display module 1140 may display an image corresponding to the captured image through the display panel 1141.

In an embodiment, when a user wishes to make a phone call, the user taps the telephone icon displayed on the display module 1140, and the processor 1110 may execute a phone application program stored in the memory 1120. A telephone keypad may be presented on the display panel 1141 for the user to enter a phone number to call.

In an embodiment, the display module 1140 may be integrated into an electronic device 1000, such as, for example, a laptop computer, smart TV, or tablet. A user wishing to access a multimedia streaming application (e.g., to watch a music video or movie) can do so by tapping the corresponding icon. This action activates the application, allowing the user to view the streamed content.

The processor 1110 may include a main processor 1111 and an auxiliary or coprocessor 1112. The main processor 1111 may include a central processing unit (CPU). The main processor 1111 may further include one or more of a graphics processing unit (GPU), a communication processor (CP), and an image signal processor (ISP).

The coprocessor 1112 may include a controller 1112-1. The controller 1112-1 may include an interface conversion circuit and a timing control circuit. The controller 1112-1 may receive an image signal from the main processor 1111, convert the data format of the image signal to match the interface specifications with the display module 1140, and output image data. The controller 1112-1 may output various control signals to drive the display module 1140. For example, the controller 1112-1 may drive the display module 1140 to display the icon on the display screen suitable for selection by a user to cause execution of an application program 1123.

The memory 1120 may store one or more application programs 1123 and various data used by at least one component (for example, the processor 1110 or the user interface 1161) of the electronic device 1000 and input data or output data for commands related thereto. For example, a camera application program, a GPS application program, an augmented reality and virtual reality application program, and other application programs that can be executed by the processor 1110 upon selection of corresponding icons presented on the display screen (or display panel 1141) via the touch screen 1142 or user interface 1161 by the user. In addition, various setting data corresponding to user settings may be stored in the memory 1120. The memory 1120 may include volatile memory 1121 and non-volatile memory 1122.

The display module 1140 may output visual information (images) to the user. The display module 1140 may include the display panel 1141, a gate driver, the source driver, a voltage generation circuit, and a touch screen 1142. The display module 1140 may further include a window, a chassis, and a bracket to protect the display panel 1141. The display module 1140 may include at least a part of the configuration of the display device 100 shown in FIG. 1.

The user interface 1161 serves as the interaction medium between a user and the electronic device 1000. The user interface 1161 may detect an input by a part (e.g., finger) of a user's body or an input by a pen or a mouse, and generate an electric signal or data value corresponding to the input. The user interface 1161 includes the fingerprint sensor 1162, the input sensor 1163, and a digitizer 1164.

The fingerprint sensor 1162 may sense a fingerprint for biometric recognition of the user and may also measure one or more biological signals such as, for example, blood pressure, moisture, or body mass.

The input sensor 1163 may sense user interactions including, for example, touch, tap, gesture, motion, spoken command, and eye movement. The input sensor 1163 includes optical sensors for image capture, eye tracking, or motion and gesture detection. Optical sensors may be infrared or semiconductor photodetectors. The input sensor 1163 includes audio and acoustic sensors, which may be MEMS microphones for voice recognition or sound-based interaction. The audio and acoustic sensors can be installed as part of the user interface 1161 or embedded in the display panel 1141.

The digitizer 1164 may generate a data value corresponding to coordinate information of input by a pen or a mouse to control movement of an onscreen cursor. The digitizer 1164 may generate the amount of change in electromagnetic due to the input as the data value. The digitizer may detect an input by a passive pen or transmit and receive data with an active pen or a remote.

At least one of the fingerprint sensor 1162, the input sensor 1163, or the digitizer 1164 may be implemented as a sensor layer formed on the top layer of the display panel 1141 through a continuous process with a process of forming elements (for example, the light emitting element, the transistor, and the like) included in the display panel 1141.

In addition, the user interface 1161 may further include, for example, a gesture sensor, a gyro sensor that senses rotational movements, an acceleration sensor to track translational movement, a grip sensor, a pressure sensor, a proximity sensor, a color sensor, an infrared (IR) emitter and camera sensor for tracking gaze direction and eye movements, a temperature sensor, or a light sensor. For example, the gyro sensor, acceleration sensor, and infrared emitter and camera may be particularly suitable for AR/VR headset functions.

The touch screen 1142 includes touch sensors embedded in semiconductor layers of the display panel 1141 to sense pressure applied to the top layer (screen) of the display panel 1141. The touch sensors can be a capacitive or a resistive type. The touch screen 1142 may serve as the primary interface for the user to select and navigate applications, control, and interact with the electronic device 1000.

The display panel 1141 (or display) may include, for example, a liquid crystal display panel, an organic light emitting display panel, or an inorganic light emitting display panel. However, the type of the display panel 1141 is not particularly limited. The display panel 1141 may be of a rigid type or a flexible type that can be rolled or folded. The display module 1140 may further include a supporter, bracket, heat dissipation member, and the like that support the display panel 1141. The display panel 1141 may include the display device shown in FIG. 1.

The power source module 1150 may supply power to the components of the electronic device 1000. The power source module 1150 may include a battery that charges the power source voltage. The battery may include a non-rechargeable primary battery or a rechargeable secondary battery or fuel cell. The power source module 1150 may include a power management integrated circuit (PMIC). The PMIC may supply optimized power to each of the components described above including the display module 1140.

As is traditional in the field of the present disclosure, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

Although the display device, the method of driving the display device, and the electronic apparatus according to embodiments of the present disclosure have been described with reference to the drawings, it will be understood by those of ordinary skill in the art that various changes in form and detail may be made therein without departing from the spirit and scope of the present disclosure as defined by the following claims.

What is claimed is:

1. A display device, comprising:
a display panel comprising a plurality of pixels,
wherein the display device is configured to display an image at a variable driving frequency;
an emission driver configured to provide an emission signal to the plurality of pixels; and
a controller configured to perform a cycle differential driving operation in which lengths of emission periods defined by the emission signal gradually increase in a frame,
wherein the controller omits the cycle differential driving operation when a change in the variable driving frequency corresponds to a frequency difference that is greater than or equal to a threshold frequency difference.

2. The display device of claim 1, wherein the controller comprises:
an emission off compensation circuit configured to calculate a compensation emission off length based on a current cycle number of an n^{th} frame, wherein n is a positive integer greater than or equal to 2;
a cycle differential driving determination circuit configured to generate a first output signal based on the current cycle number and a previous cycle number of an n−1^{th} frame; and
an emission off length output circuit configured to output the compensation emission off length as a current emission off length of a current cycle of the emission signal to the emission driver when the first output signal has a deactivation value.

3. The display device of claim 2, wherein the emission off length output circuit outputs a reference emission off length of the emission signal as the current emission off length to the emission driver when the first output signal has an activation value.

4. The display device of claim 2, wherein the emission off length output circuit outputs a previous emission off length of a previous cycle prior to the current cycle as the current emission off length to the emission driver when the first output signal has an activation value.

5. The display device of claim 2, wherein the cycle differential driving determination circuit includes:
a frequency difference calculator circuit configured to calculate a difference value obtained by subtracting the previous cycle number from the current cycle number; and
a frequency difference comparator configured to output a deactivation value when the difference value is less than a threshold value corresponding to the threshold frequency difference, and output an activation value when the difference value is greater than or equal to the threshold value.

6. The display device of claim 5, wherein the cycle differential driving determination circuit further comprises:
a storage configured to store the previous cycle number at a start of the n^{th} frame.

7. The display device of claim 5, wherein the cycle differential driving determination circuit further comprises:
a first logic gate configured to generate a third output signal based on a frequency difference determination enable signal and a second output signal of the frequency difference comparator.

8. The display device of claim 7, wherein the first logic gate is an AND gate.

9. The display device of claim 7, wherein the cycle differential driving determination circuit further comprises:
a second logic gate configured to generate the first output signal based on a cycle differential driving bypass signal and the third output signal.

10. The display device of claim 9, wherein the second logic gate is an OR gate.

11. The display device of claim 2, wherein the cycle differential driving determination circuit comprises:
a frequency difference calculator circuit configured to calculate a difference value obtained by subtracting the previous cycle number from the current cycle number; and
a frequency difference comparator configured to output a deactivation value or an activation value based on the difference value, a threshold value corresponding to the threshold frequency difference, and a frequency direction signal.

12. The display device of claim 11, wherein the frequency difference comparator outputs the deactivation value when the frequency direction signal has a first value and the difference value is less than the threshold value, and outputs the activation value when the frequency direction signal has the first value and the difference value is greater than or equal to the threshold value.

13. The display device of claim 12, wherein the frequency difference comparator outputs the deactivation value when the frequency direction signal has a second value and the threshold value is less than the difference value, and outputs the activation value when the frequency direction signal has the second value and the threshold value is greater than or equal to the difference value.

14. The display device of claim 1, wherein each of the plurality of pixels comprises:
a light-emitting element;
a driving transistor configured to apply a driving current to the light-emitting element; and
a bias transistor configured to apply a bias voltage to the driving transistor.

15. The display device of claim 14, wherein, when the variable driving frequency changes from a high frequency to a low frequency, a voltage level of the bias voltage in a first low-frequency frame having the low frequency is set higher than a voltage level of the bias voltage in a high-frequency frame having the high frequency.

16. The display device of claim 15, wherein, when the driving frequency changes from the high frequency to the low frequency, a voltage level of the bias voltage in a second low-frequency frame having the low frequency is set lower than the voltage level of the bias voltage in the first low-frequency frame and higher than the voltage level of the bias voltage in the high-frequency frame.

17. A method of driving a display device, the method comprising:
storing a previous cycle number of an n−1^{th} frame at a start of an n^{th} frame, wherein n is a positive integer greater than or equal to 2;
comparing a current cycle number of the n^{th} frame with the previous cycle number;
performing a cycle differential driving operation in which lengths of emission periods gradually increase in a frame when a value obtained by subtracting the previous cycle number from the current cycle number is less than a threshold value; and
omitting the cycle differential driving operation when the value obtained by subtracting the previous cycle number from the current cycle number is greater than or equal to the threshold value.

18. The method of claim 17, wherein performing the cycle differential driving operation comprises:
generating an emission signal based on a compensation emission off length calculated based on the current cycle number.

19. The method of claim 17, wherein omitting the cycle differential driving operation comprises:
generating an emission signal based on a reference emission off length of the emission signal or a previous emission off length of a previous cycle prior to the current cycle.

20. An electronic apparatus, comprising:
a display panel comprising a plurality of pixels,
wherein the display panel is configured to display an image at a variable driving frequency;
an emission driver configured to provide an emission signal to the plurality of pixels;
a controller configured to perform a cycle differential driving operation in which lengths of emission periods defined by the emission signal gradually increase in a frame; and
a processor configured to provide image data to the controller,
wherein the controller omits the cycle differential driving operation when a change in the variable driving frequency corresponds to a frequency difference that is greater than or equal to a threshold frequency difference.
